(19) United States
(12) Patent Application Publication
(10) Pub. No.: US 2010/0206418 A1
(43) Pub. Date: Aug. 19, 2010

(54) METHOD FOR CONNECTING PIPES AND PIPE HAVING A PROFILED FACE END

(76) Inventors: Michael Wolf, Bremen (DE); Manfred Peschka, Aachen (DE)

Correspondence Address: ST. ONGE STEWARD JOHNSTON & REENS, LLC, 986 BEDFORD STREET, STAMFORD, CT, 06905-5619, US

(21) Appl. No.: 12/710,946

(22) Filed: Feb. 23, 2010

Related U.S. Application Data
(63) Continuation of application No. PCT/EP2008/060514, filed on Aug. 11, 2008.

(30) Foreign Application Priority Data
Aug. 24, 2007 (DE) 10 2007 040 452.4

(51) Int. Cl. F16L 9/00; F16L 9/02; F16L 25/00; B32B 37/00; B32B 37/12

(52) U.S. Cl. 138/109; 285/332.2; 156/60; 156/330; 138/155

(57) ABSTRACT

A pipe, particularly a pipeline pipe having a first and a second face end, wherein the two face ends are profiled such that two identically profiled pipes can be connected to each other by way of a glued plug-in connection of a first face end of one pipe to the second face end of the second pipe, wherein the plug-in connection has a centering section and a gluing section, wherein a stop step of the first pipe abuts a counter stop step of the second pipe in the centering section such that an annular gap, which is open toward the outside of the pipes and is filled with glue in the connected state, is formed in the gluing section. It is essential that the annular gap is formed by two gap walls extending substantially parallel to each other and tilted at an acute angle to the pipe axis.

### CROSS-REFERENCE TO RELATED APPLICATIONS

The present application is a continuation of pending International patent application PCT/EP2008/060514 filed on Aug. 11, 2008 which designates the United States and claims priority from German patent application 10 2007 040452.4 filed on Aug. 24, 2007, the content of which is incorporated herein by reference.

### FIELD OF THE INVENTION

The invention relates to a pipe, in particular a pipeline pipe with a first and a second end, the two ends being profiled in such a manner that two pipes that are profiled in the same way can be connected to one another in the course of an adhering plugging connection of a first end of one of the pipes to the second end of the second pipe, the plug connection having a centring portion and an adhering portion, it being the case that in the centring portion, a stop step of the first pipe engages against a counter stop step of the second pipe in such a manner that, in the adhering portion, an annular gap is formed, the gap being open toward the outer side of the pipes and, in the connected condition, being filled with adhesive.

### BACKGROUND OF THE INVENTION

The invention also relates to a connection of two pipes to one another, in particular pipeline pipes, by their respective profiled ends in the course of an adhering plugging connection, the plug connection having a centring portion and an adhering portion, it being the case that in the centring portion, a stop step of the first pipe engages against a counter stop step of the second pipe in such a manner that, in the adhering portion, an annular gap is formed, the gap being open toward the outer side of the pipes and being filled with adhesive.

The invention also relates to a method for connecting two pipes of a pipeline or the like at their respective ends, pipes being used that have an end profiling for the purpose of engaging the two pipes into one another and adhering them to one another.

The pipes according to the invention consist of steel and in particular of a high-alloyed steel. Pipelines are produced using these pipes, which typically have a diameter of a metre or more. The pipelines consist of a multiplicity of pipes that are connected to one another in each case at their ends. If pipes of this kind are welded, crack initiation, blowholes, porosities and the like may come about as a result of the high-alloyed steel.

A pipe connection of the generic kind is known from DE 10 2005 013859 A1. A first pipe end has an end recess which is of circular shape and has a diameter that is greater than the diameter of the end of a second pipe. The second, thinner pipe is provided with an adhesive layer and is engaged into the recess.

### SUMMARY OF THE INVENTION

It is an object of the invention to effect technical improvement in the production of pipelines.

This object is met by the invention specified in the claims, each claim representing an independent solution to the problem and being combinable with any other claim.

First and foremost, it is provided that pipeline pipes of steel are used for pipes that can be engaged into one another and adhered to one another. Furthermore, a special profile is provided for the ends of the pipes, so that the pipes are centred while they are being engaged together, and thereby, a defined thickness is set for the adhesive layer. The plug connection has for this purpose a centring portion and an adhering portion. The two portions are preferably located one after the other in the axial direction, the centring portion being on the inner side of the wall of the pipe and the adhering portion being substantially on the outer side of the wall of the pipe. The centring portion provides a stop zone. In this stop zone, a stop step of one of the pipes engages against a counter stop step of the other pipe in the connected-together state. In this stop position, there is formed in the adhering portion, a gap which is open toward the outer side of the pipe and has a gap width between about 0.1 and 10 mm. Preferably the gap width is 1 to 3 mm. This joint has the shape of an annular gap and in the final condition is filled with adhesive. The annular gap is preferably formed by two gap walls which extend substantially parallel and inclined at an acute angle to the axis of the pipe. Thus each pipe defines in each case one of the two gap walls. The two gap walls lie respectively on a conical outer lateral surface and on a conical inner lateral surface. Contact surfaces adjoin these two gap walls in each case. These contact surfaces belong to the centring portion and extend on cylindrical lateral surfaces. A first pipe therefore provides a stop step on the inner side of the pipe, the stop step defining the base of a cylindrical recess and the axis of the cylinder coinciding with the axis of the pipe. The lateral wall of this cylindrical portion is formed by the contact surface. The second pipe defines a portion which is congruent to this. This cylindrical portion has a longer cylindrical lateral surface. The diameters of the two cylindrical lateral surfaces are matched to one another so that the two pipes are centered when they are engaged together. The centring action is facilitated by the slopingly extending gap wall which is located ahead of the contact surface. This forms as it were a guiding funnel for the end of the other pipe. The adhesive layer may be applied on site. Preferably a single-component or two-component adhesive is used. Epoxy resin, polyurethane or methylmethacrylate may be considered as material for the paste-like adhesive. The adhesive may also be pre-applied. It is then activated before or during the engaging together of the two pipes. This may be effected by means of a heating sleeve. The thickness of the adhesive must equate to at least the gap width of the annular gap in the assembled position. Preferably the adhesive layer has a layer thickness that is a little greater that the gap width of the annular gap. The thickness of the adhesive is however matched to the length of the centring portion so that the adhesive layer only comes into contact with the opposite gap wall when the outward cylindrical portion has entered into the inward cylindrical portion, the two pipes having therefore been centred. The layer thickness of the adhesive layer corresponds to somewhat more than the gap width and is thus also between 0.1 and 10 mm, preferably 1 to 3 mm. Pushing-in into the abutment position is then effected by application of an axial force and optionally with simultaneous heating up of the bonding location for activation of the adhesive until such time as the stop position has been reached. In the course of this axial displacement, the adhesive layer is compressed as a result of the gap walls coming closer to one another. Since the annular gap in the direction of the inner side of the pipe is closed off by the outward cylindrical portion, the excess adhesive can only exit toward the exterior through the gap opening. In this way, an annular circumferential bead is formed by the adhesive which has welled-up out of the annular gap. It is therefore possible to establish by eye that a complete adhesive bond has been achieved all the way around the circumference. If this adhesive bead has interruptions, any defect in the adhesive bond can therefore be detected immediately. The profiling of the pipe ends may be effected both by the pipe manufacturer and also on site. In particular, when the profiling has been effected in advance by the pipe manufacturer, pre-treatment of the adhering surfaces, i.e. of the gap walls, is necessary, for example by sand blasting. If pre-applied adhesive is used, a heating sleeve is required for thermal activation of the adhesive. This may be effected by resistance heating or by induction heating or by combustion. Using a heating sleeve, the gap wall carrying the adhesive is preferably not heated up, but rather the other pipe end. This overlaps the gap wall coated with adhesive.

### BRIEF DESCRIPTION OF THE DRAWINGS

An embodiment of the invention will be explained below with reference to accompanying drawings, in which:

FIG. 1 shows, in a cross-sectional illustration, the two end profiles of one or two pipes;

FIG. 2 shows an illustration in accordance with FIG. 1, but with an adhesive layer applied to a wall of the annular gap;

FIG. 3 shows a follow-up illustration in which the two pipe ends have been pushed into one another to an extent such that a centring action has taken place, but the adhesive layer has not yet come into contact with the wall on the opposite side of the gap;

FIG. 4 shows a follow-up illustration in which the two pipe ends have been brought together into the stop position, and

FIG. 5 shows an enlarged illustration of the pipe connection.

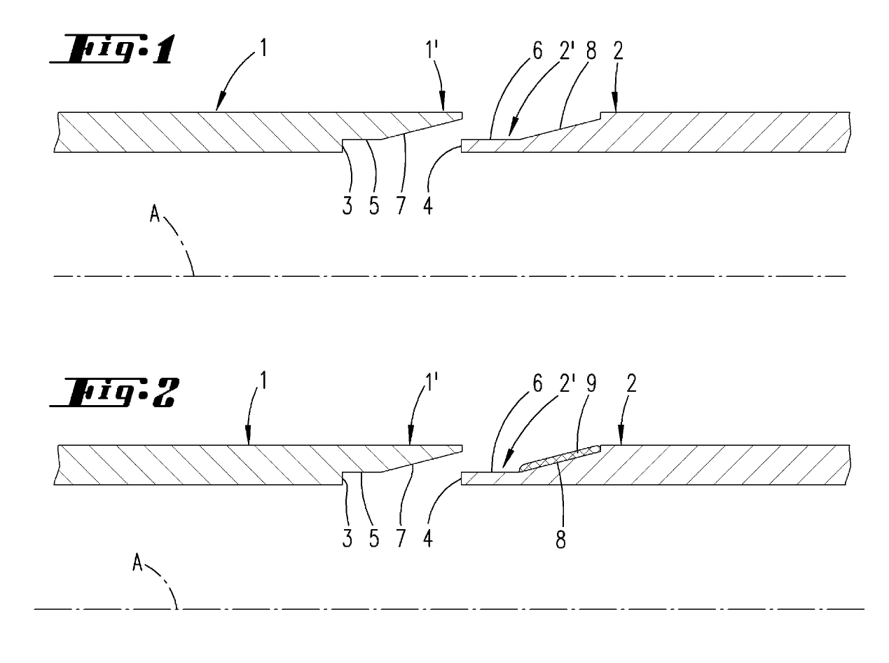

### DETAILED DESCRIPTION OF THE INVENTION

In the exemplary embodiment, the end 1′ of a first pipe 1 and the end 2′ of a second pipe 2 are shown. The other end of the first pipe 1 may have a profile similar to the illustrated end 2′ of the second pipe 2. The other end of the pipe 2 may be profiled as for the illustrated end 1′ of the first pipe 1, so that a plurality of similarly configured pipes may be engaged into one another.

The end 1′ of the first pipe 1 has first of all a radially outwardly directed stop step 3 which is spaced from the end and lies on a circular plane. A contact surface 5 adjoins this stop step 3 and extends on an inwardly cylindrical lateral surface. The contact surface 5 runs offset toward the interior of the pipe as compared with the middle of the wall of the pipe 1.

A surface 7 which extends at a slope with respect to the axis A of the pipe adjoins the internal cylindrical surface 5. The surface 7 extends on an internal conical lateral wall. The end of this sloping wall 7 which is at the pipe end makes the transition to the outer wall of the pipe with the formation of a step.

The profile of the end 2′ of the pipe 2 is configured to be substantially congruent to the foregoing, a cylindrical outer surface 6 being however longer than the cylindrical inner surface 5. The end of the pipe 2 is formed by an annular step 4, which runs in a plane and has approximately the dimension of the abutment step 3 and functions as a counter abutment step 4 for the abutment step 3. The cylindrical lateral outer surface 6 already mentioned adjoins this counter abutment step 4. The diameter is slightly less than the diameter of the internal cylindrical surface 5, so that the annular cylindrical portion formed by the surface 6 can be inserted to fit into the cylindrical opening 3, 5. The surface 6 forms therefore a counter contact surface for the contact surface 5.

A slopingly extending surface portion 8 adjoins the counter contact surface 6 and runs on a conical outer lateral wall. The two slopingly extending surfaces 7, 8 form in their connected-together condition the parallel extending walls of an annular gap 10. The end of the gap wall 8 facing the outer side of the pipe runs into a small step, which itself in turn runs into the outer lateral wall of the pipe 2.

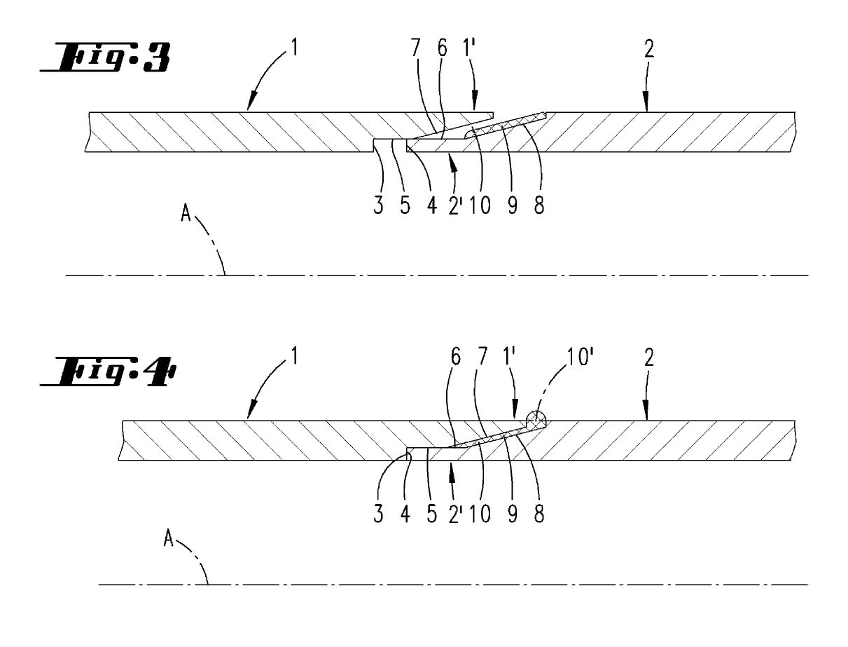

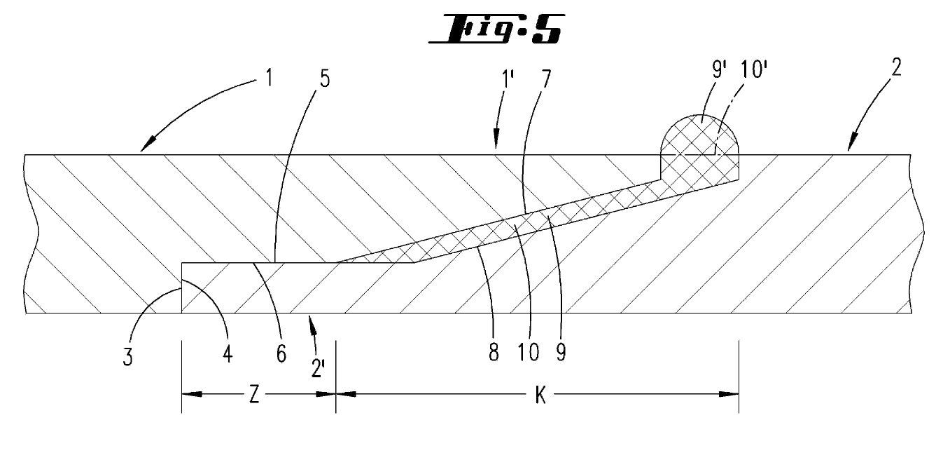

With the profiling described above, a plug-in adhesive connection is possible between two steel pipes. The pipes may consist of high-alloyed steel and may have for example a diameter of 1.2 m. An adhesive layer 9 is applied to the outwardly facing sloping gap wall 8 (see FIG. 2). This is effected by machine either on site or during manufacture of the pipe. The profiles of the pipe ends are pretreated before application of the adhesive layer 9. They may for example be sand-blasted, in order to achieve optimal adhesion of the adhesive 9 to the surfaces 7, 8.

A pasty substance may be considered for the adhesive. A single component adhesive may be used, a two-component adhesive and/or an epoxy material, a polyurethane material, or a methylmetacrylate. The adhesive layer may be protected by a covering film. This is removed before the pipes are engaged into one another.

As is to be seen from FIG. 3, the pipes are inserted into one another in such a way that the end surface 4 of the pipe 2 can impinge on the slopingly extending wall 7 of the pipe 1. In this way, a centring action is effected so that the cylindrical portion 6 finds the cylindrical inner portion 5. Only when the annular cylindrical portion of the pipe 2 has partially entered into the cylindrical portion of the pipe 1, can the adhesive layer 9 come into contact with the opposite wall 7 of the gap. The two pipes can then be urged toward one another by an axial force until the counter stop step 4 comes into contact with the stop step 3. Since the adhesive 9 cannot escape radially inward, it must emerge through the opening 10′ of the annular gap 10. This excess adhesive 9′ indicates that the adhesive connection has been made all the way round the circumference.

Radially inward welling-out of the adhesive 9 is—as is shown in FIG. 3—not possible, since the cylindrical annular portion 4, 6 has entered and fitted into the cylindrical inner portion 3, 5 before the adhesive 9 is compressed.

The surfaces 3, 4, 5, 6 provide a fitting-together action and a centring portion Z. The annular gap 10 forms, by way of the gap walls 7 and 8, the adhering portion K, which lies next to the centring portion Z in the axial direction.

Adhesives that can be pre-applied are especially suitable as adhesives. In the exemplary embodiment, the main component of the organic part of the adhesive that can be pre-applied consists of acrylate, methacrylate, polyurethane, phenol resin, or epoxy resin, in monomeric, oligomeric or polymeric form. Preferred embodiments of pre-applicable adhesives are described in more detail below:

Reactive adhesives which can be pre-applied and are stickily adhesive are preferably covered by a protective film or protective paper after being applied to the sloping surface, as is generally customary according to the prior art, e.g. for self-adhesive labels. The purpose of this protective film or this protective paper is to protect the sticky adhesive from contamination. The advantage of this embodiment of the invention is that the two pipes are fixedly connected to each other immediately after the adhesive has hardened. The strength and durability of conventional sticky adhesives is however in no way sufficient under the typical conditions of use for a pipeline, so that a cross-linking to form a duromer adhesive with permanent bonding must be effected. The sticky adhesives—preferably based on acrylates, polychloroprene or polyisoprene—must as a result contain chemical groups which are subsequently amenable to a cross-linking reaction under site conditions. Examples of these are:
acrylate groups (bonded to the base polymers or in the form of low-molecular acrylates), which are cross-linked by micro-encapsulated peroxides, the peroxides being released from the microcapsules by thermal action or by mechanical pressure;
copolyacrylates containing stickily adhesive acrylates (e.g. isooctylacrylate) and acrylates containing hydroxyl groups (e.g. 2-hydroxyethylacrylate or 2-hydroxymethacrylate), which are cross-linked by thermally activatable blocked isocyanates (e.g. Desmodur TT, Rheinchemie).

For the embodiments of the invention which are based on adhesives that can be pre-applied and have a dry surface, covering-over of the adhesive is normally not necessary, but may be used to used to protect the adhesive layer from contamination. Adhesives of this kind may have a different base. Examples are mentioned below:
solid polyesterpolyols (e.g. polycaprolactone (e.g. CAPA from Solvay)) or polyhexanedioladipates (e.g. Dynacoll from Degussa), which are formulated with thermally activatable blocked isocyanates (e.g. Desmodur TT, Rheinchemie). Application to the substrate to be precoated is effected in the form of a melt.
solid epoxidated phenol resins (e.g. Novolak epoxy resin, EPR 600 from Hexion), which are formulated with dicyanodiamide (e.g. Dyhard 100 from Degussa) and optionally urones (e.g. UR 300 from Degussa) as hardening accelerator. Application to the substrate to be precoated is effected in the form of a melt.
aqueous dispersions of a solid bisphenol A or epoxy resin based on epoxidated Novolak (e.g. EPI-REZ Resin 3522-W-60 from Hexion), which is formulated with dicyanodiamide (e.g. Dyhard 100 from Degussa) and optionally a urone as hardening accelerator (e.g. UR 500 from Degussa). Application to the substrate to be precoated is effected e.g. by spraying-on of the aqueous dispersion. After evaporation of the water, a dry adhesive layer is achieved, which becomes sticky under heat and hardens out as an adhesive of high strength.

The cross-linking reaction is induced thermally after the components have been joined together. Preferred embodiments for introducing heat into the adhesive layer on site are hot air, electrically heated heating strips or heating cushions, and inductive heating of the metallic substrate material (e.g. the steel of which the pipe and/or the pipeline consists). These methods of heating are known in principle in the prior art and require merely to be adapted to the present invention.

All features disclosed are (in themselves) pertinent to the invention. The disclosure content of the associated/attached priority documents (copy of the prior application) is hereby also included in full in the disclosure of the application, also for the purpose of incorporating features of these documents in claims of the present application.

1. A steel pipe, in particular a pipeline pipe with a first and a second end, the two ends being profiled in such a manner that two pipes that are profiled in the same way can be connected to one another in the course of an adhering plugging connection of a first end of one of the pipes to the second end of the second pipe, the plug connection having a centring portion and an adhering portion, it being the case that in the centring portion, a stop step of the first pipe, which stop step is formed at the end of a contact surface that extends on an inwardly cylindrical lateral surface, engages against a counter stop step that is disposed at the end of a counter contact surface of the second pipe, and, in the adhering portion, an annular gap is formed, the gap being open toward the outer side of the pipes and, in the connected condition, being filled with adhesive, characterized in that the contact surface engages against an outwardly cylindrical counter contact surface that runs congruently to the surface, that the annular gap is formed by two gap walls that run substantially parallel to one another and inclined at an acute angle to the axis of the pipe on a conical inner lateral wall and a conical outer lateral wall, and that the layer thickness of the adhesive applied to the conical outer lateral wall of the first pipe is greater than the width of the gap, so when the two pipes are engaged together, the gap toward the inner side of the pipe is first of all closed by the outwardly cylindrical counter contact surface before the adhesive layer applied to the conical outer lateral wall comes into contact with the gap wall opposite the wall and subsequently excess adhesive exiting through the gap opening forms an annular circumferential bead.

2. The steel pipe according to claim 1, characterized in that the surface of the centring portion that extends on an outer lateral surface of a cylinder extends all the way to the adhering portion and forms a wall, extending in the radial direction, of the annular gap.

3. The steel pipe according to claim 1, characterized in that the annular gap has a gap width of 0.1 to 10 mm.

4. The steel pipe or according to claim 1, characterized in that the adhesive is a thermally activatable adhesive.

5. The steel pipe according to claim 4, characterized in that the thermally activatable adhesive is applied during the manufacture of the pipe or during the profiling of the end.

6. The steel pipe according to claim 5, characterized in that the adhesive layer is applied to the gap wall that runs at the acute angle relative to the axis of the pipe and faces outward and is activatable by heating up the end of the end of the other pipe that has the inwardly facing gap wall.

7. A connection of a first end of a first steel pipe to a second end of a second steel pipe, in particular two pipeline pipes, the two profiled ends being connected to one another in the course of an adhering plugging connection, the plug connection having a centring portion and an adhering portion, it being the case that in the centring portion, a stop step of the first pipe, which stop step is formed at the end of a contact surface that that extends on an inwardly cylindrical lateral surface, engages against a counter stop step that is disposed at the end of a counter contact surface of the second pipe, and, in the adhering portion, an annular gap is formed, the gap being open toward the outer side of the pipes and being filled with adhesive, characterized in that the contact surface engages against an outwardly cylindrical counter contact surface that runs congruently to the surface, that the annular gap is formed by two gap walls that run substantially parallel to one another and inclined at an acute angle to the axis of the pipe on a conical inner lateral wall and a conical outer lateral wall and is closed toward the inner side of the pipe by the outwardly cylindrical counter contact surface.

8. The connection of two pipes according to claim 7, characterized in that the annular gap has a gap width of 0.1 to 10 mm.

9. The connection of two pipes according to claim 7, characterized in that the adhesive is a thermally activatable adhesive.

10. A method for connecting two steel pipes, in particular pipeline pipes that have a first and a second end, the two ends being profiled in such a manner that two similarly profiled pipes can be connected to one another in the course of an adhering plugging connection of a first end of one of the pipes with the second end of the second pipe, the plug connection having a centring portion and an adhering portion, it being the case that in the centring portion, a stop step of the first pipe that is formed at the end of a contact surface extending on an inwardly cylindrical lateral surface engages against a counter stop step disposed at the end of a counter contact surface of the second pipe, and, in the adhering portion, an annular gap is formed, the gap being open toward the outer side of the pipes and, in the connected condition, being filled with adhesive, the contact surface engaging against an outwardly cylindrical counter contact surface that runs congruently to the surface, the annular gap being formed by two gap walls that run substantially parallel to one another and inclined at an acute angle to the axis of the pipe on a conical inner lateral wall and a conical outer lateral wall, characterized in that the layer thickness of the adhesive applied to conical outer lateral wall of the first pipe is greater than the gap width of the annular gap, that when the two pipes are engaged together, the gap toward the inner side of the pipe is first of all closed by the outwardly cylindrical counter contact surface before the adhesive layer applied to the conical outer lateral wall comes into contact with the gap wall opposite the wall and subsequently excess adhesive exiting through the gap opening forms an annular circumferential bead.

11. The method according to claim 10, characterized in that the adhesive layer is thermally activatable and is activated by heating up of the pipe after the two pipe ends have been engaged together.

12. The method according claim 10, characterized in that a pasty adhesive is used as adhesive, in particular a single-component adhesive or a two-component adhesive.

13. The method according to claim 10, characterized in that EP, PUR and/or MMA is used as adhesive.

14. The method according to claim 10, characterized in that the adhesive layer is applied during the manufacture of the pipe or during the profiling of the end and is thermally activatable.

15. The method according to claim 10, characterized in that the adhesive layer is thermally activatable and is activated by heating up of the pipe.

16. The method according to claim 10, characterized in that the adhesive layer is applied to the gap wall that runs at the acute angle relative to the axis of the pipe and faces outward, and is activated by heating up of the end of the end of the other pipe that has the inwardly facing gap wall.

17. The steel pipe according to claim 3, characterized in that the annular gap has a width of 1 to 3 mm.

18. The steel pipe or according to claim 1, characterized in that the adhesive has components selected from the group consisting of EP, PUR and MMA and combinations of these.

19. The connection of two pipes according to claim 8, characterized in that the annular gap has a width of 1 to 3 mm.

20. The method according to claim 13, characterized in that the adhesive is selected from the group consisting of EP, PUR and MMA and mixtures of these.
